(19) United States
(12) Patent Application Publication
(10) Pub. No.: US 2004/0205534 A1
(43) Pub. Date: Oct. 14, 2004

(54) System and method for providing access to forms and maintaining the data used to complete the forms

(76) Inventor: Steven K. Koelle, San Antonio, TX (US)

Correspondence Address: OFFICE OF THE STAFF JUDGE ADVOCATE, U.S. ARMY MEDICAL RESEARCH AND MATERIEL COMMAND, ATTN: MCMR-JA (MS. ELIZABETH ARWINE), 504 SCOTT STREET, FORT DETRICK, MD, 21702-5012, US

(21) Appl. No.: 10/141,339

(22) Filed: May 9, 2002

Related U.S. Application Data
(63) Continuation-in-part of application No. PCT/US01/15666, filed on May 16, 2001.
(60) Provisional application No. 60/204,570, filed on May 16, 2000.
(60) Provisional application No. 60/289,531, filed on May 9, 2001.
(60) Provisional application No. 60/289,531, filed on May 9, 2001.

(51) Int. Cl. H04K 1/00

(52) U.S. Cl. 715/507; 705/72

(57) ABSTRACT

An apparatus and method for providing a forms system that preferably allows easy access to a large number of forms, a user to electronically sign a form, authentication of the data has not changed after the form has been electronically signed, data conversion, and external data importation into a data file. A further embodiment of the invention preferably includes a method to incorporate signature capabilities into a form. Another aspect of the invention is consistent handling of data entered into forms by users.

This is a continuation-in-part application of PCT Application Number PCT/US01/15666, filed on May 16, 2001 (published in English on Nov. 22, 2001), which claims priority from U.S. provisional patent application serial No. 60/204,570, filed on May 16, 2000 and U.S. provisional patent application serial No. 60/289,531, filed on May 9, 2001; and this application claims the benefit of U.S. provisional patent application serial No. 60/289,531, filed on May 9, 2001. Each of these applications is hereby incorporated by reference.

### I. FIELD OF THE INVENTION

This invention relates to a system for providing a series of electronic forms to multiple users while allowing for easy management of the forms database on a central location at any one particular site or for a collection of sites.

### II. BACKGROUND OF THE INVENTION

One of the most significant inefficiencies in government and corporations is the cumbersome nature of manual, paper-based processes. Prior systems have been unable to replace the slow movement of physical paper forms, which leads to lost forms and paperwork and reduced efficiencies.

The presently available forms systems require extensive end user training to learn to use commercial off-the-shelf electronic forms software such as FormFlow Filler available from JetForm Corporation headquartered in Ottawa, Ontario, Canada. This software has roughly an 80% share of the electronic forms market. Use of FormFlow requires that the users be trained in the use of the application, because in part the software is not intuitive. That software does not provide for a standard storage system for the data entered to fill out a particular form, thus data will need to be reentered whenever the user forgets where he/she saved the data. The forms database allows for multiple versions of the same electronic form to be in use, each of which may have incompatible data structures and/or be an out-of-date form.

Another system providing similar functionality to that of the instant system is IP LegalForm available from LegalStar based in Amherst, N.Y. This system provides an interface for accessing a forms database through individual client directories or as a standalone form. A user selects to open a form from the database or a previously created form. Within the forms database there are subcategories for different types of intellectual property forms divided into patent, trademark, service mark, PCT, and custom. Once a form is selected the user may insert the appropriate data into the form to populate it. The user may print and/or save the data in the form for later reference/use. A primary drawback to this system is that client directories are not automatically placed into order, thus as the number of client directories increases, the user needs to remember approximately where in the client directories a particular client's directory is located. This system allows the user to install updated forms into the system as forms change and/or are replaced.

Another form filling out system commonly available is Adobe portable document format (PDF) software that now allows for forms to be completed on-line while an user browses a particular website. An example of this is the Copyright Office (www.loc.gov/copyright) forms that may be completed on-line and then printed for filing, which printing defeats the purpose of submitting forms electronically. One drawback to the Copyright Office's implementation is that the forms are unable to be saved for later modification if an error is found after the user has continued to browse and surf to other web pages. However, PDF forms do provide for the forms to look the same no matter what the underlying operating system of the computer and/or the printer used to produce/print the PDF form is.

Another problem is that the Government Paperwork Elimination Act was enacted in October 1998 that dictates that federal agencies develop electronic versions of their forms that are able to accept electronic signatures on forms that require a signature as an option by October 2003. See e-Process for e-Government White Paper, p. 3 (JetForm March 2000). It has been estimated that the U.S. Government has over 6,000 different forms that lead to over 20 billion responses each year. Similar legislation has been adopted in a variety of states and foreign countries. The problem then becomes how will individuals be able to effectively save the data placed on electronic forms along with verifying that the forms have not been modified or changed since a signature has been placed on the electronic form. The presently available software and systems known to the applicant do not provide these features, especially while providing an easy to use interface.

With this push to make forms available solely in electronic form, average users need to be able to readily access and use these forms in an electronic medium. If users are printing out the electronic forms prior to submission, then the underlying purpose of reducing the mounds of paper stored by users and government is not met. Furthermore, existing privacy and security technologies are immature and have yet-unresolved issues regarding electronic records and authentication. See e-Process for e-Government White Paper, p. 4.

Notwithstanding the usefulness of the above-described methods, a need still exists for a system that is intuitive with a variety of features, for example, including electronic signature and organized and easily accessed databases with form content.

### III. SUMMARY OF THE INVENTION

This invention preferably provides a menu-driven system designed to allow users to identify, navigate and find forms, and establishes defaults for saving forms.

An apparatus for managing multiple forms in accordance with the invention includes a forms database, at least one content database for inputted data, a forms interface, and an overlay.

A method for placing a signature on a form in accordance with the invention includes receiving a signature request from a user, retrieving the signature, performing a security verification that the signature corresponds to the requesting user, and adding the signature to the form.

A method for providing information regarding a form to a user in accordance with the invention includes receiving an information request from the user, and displaying information regarding the form to the user.

A method for adding data to a data file for a particular form in accordance with the invention includes receiving a request from a user to pull data from a source external to the current data file, prompting the user for a location of the external data, receiving location information from the user, pulling the external data based upon the location information, and adding the external data to the current data file.

A method for displaying signature information without displaying the signature in accordance with the invention includes determining whether a data to populate a form includes a signature, when the data includes a signature performing the following pulling information regarding the signature, authenticating the populating data to verify no changes have occurred in data fields linked to the signature, and when no changes have occurred displaying the signature information in place of the signature.

A method for converting a data file for an old form replaced by a new form in accordance with the invention includes renaming the data file for the old form, creating a data file using the former name of the data file for the old form, and translating the data from the data file for the old form to the data file for the new form.

A method for adding a signature functionality to a form in accordance with the invention includes locating in the form signature template fields such that a signature field covers an area where a signature is to be located and an option for informing a form system to insert a signature in the signed field within the signature area of the form.

A system in accordance with the invention includes means for providing a main interface, means for allowing an user to access a form within three clicks beginning at the main interface, means for displaying a form with at least one field that the user may fill with data, and means for storing data entered into the fields of forms within said system.

An objective of the invention is to manage an infinite number of electronic forms.

Another objective of the invention is to provide a simple point and click function using intuitive options to perform all electronic forms management tasks.

Another objective of the invention is to have the most current version of every available electronic form within the system to prevent users from using outdated forms.

Another objective of the invention is to move form information throughout the organization when used in conjunction with an electronic mail system.

Another objective of the invention is that each user will be able to customize a personal menu to contain selected forms and any personal forms.

Another objective of the invention is flexibility and customability to fit a particular set of forms of an organization.

Another objective of the invention is to provide a standardized naming convention for form and data files.

A further objective of the invention is that each department or subpart be able to customize a department menu to contain selected forms and department forms.

A further objective of the invention is that electronic forms may be accessed by form number, form category, or key word selection.

Yet another objective of the invention is to link help information to each component within the system to assist users and answer their questions thus decreasing the amount and number of man hours answering users' questions.

An advantage of the invention is no, or at least very little training is required to bring users up to speed on the system.

Another advantage of the invention is a reduction in the number of paper stock forms and the management of those paper forms.

Another advantage of the invention is a standard set of forms throughout an organization.

A further advantage of the invention is the ability to locate a form by either classification by category or word search, thus enhancing the user's ability to locate forms.

Given the following enabling description of the drawings, the apparatus should become evident to a person of ordinary skill in the art.

### IV. BRIEF DESCRIPTION OF THE DRAWINGS

FIG. 1 illustrates an opening user interface according to an embodiment of the present invention.

FIG. 2 depicts a form subgroup interface according to an embodiment of the present invention.

FIG. 3 illustrates a forms interface according to an embodiment of the present invention.

FIG. 4 depicts a form information interface according to an embodiment of the present invention.

FIG. 5 illustrates an additional form information screen according to an embodiment of the present invention.

FIG. 6 depicts a method for obtaining form information according to an embodiment of the present invention.

FIG. 7 illustrates a form data entry interface according to an embodiment of the present invention.

FIG. 8 depicts a method for adding a signature to a form according to an embodiment of the present invention.

FIGS. 9-13 illustrate various interfaces relating to the method depicted in FIG. 8.

FIG. 14 depicts a message window according to an embodiment of the present invention.

FIG. 15 illustrates the removal of a signature according to an embodiment of the present invention.

FIG. 16 depicts a message window according to an embodiment of the present invention.

FIG. 17 illustrates the placement of multiple signatures on a form according to an embodiment of the present invention.

FIG. 18 depicts a method for importing and/or restoring data to a data file according to an embodiment of the present invention.

FIGS. 19-23 illustrate interfaces/information windows useful in conjunction with the method depicted in FIG. 18.

FIG. 24 depicts a method for converting data files according to an embodiment of the present invention.

FIG. 25 illustrates an interface according to an embodiment of the present invention.

FIG. 26 depicts a block diagram according to an embodiment of the present invention.

FIG. 27 illustrates a form displayed in a system without signature capabilities according to an embodiment of the present invention.

FIG. 28 depicts a method for displaying signature data that is depicted in FIG. 27.

FIG. 29 illustrates an embodiment of the present invention.

FIG. 30 depicts an embodiment of the present invention.

### V. DETAILED DESCRIPTION OF THE DRAWINGS

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. The accompanying drawings show preferred embodiments of the invention. Like reference numbers refer to like elements throughout.

As will be appreciated by one of skill in the art, the present invention may be embodied as a method, data processing system, and/or computer program. Accordingly, the present invention may take the form of an entirely hardware embodiment, an entirely software embodiment or an embodiment combining software and hardware aspects. Furthermore, the present invention may take the form of a computer program on a computer-usable storage medium having computer-usable program code embodied in the medium. Any suitable computer readable medium may be utilized including hard disks, CD-ROMs, optical storage devices, or other magnetic storage devices.

The program code may execute entirely on the user's computer, as a stand-alone software package; on a remote computer; or it may execute partly on the user's computer and partly on a remote computer. In the latter scenario, the remote computer may be connected directly to the user's computer through a LAN or a WAN (Intranet), or the connection may be made indirectly through an external computer (for example, through the Internet using an Internet Service Provider and/or proxy server).

The present invention is described below with reference to flowchart illustrations of methods, apparatus (systems) and computer programs in accordance with the several embodiments of the invention. It will be understood that each block of the flowchart illustrations, and combinations of blocks in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. Examples of how the software can be stored for use are the following: in random access memory (RAM); in read only memory (ROM); on a storage device like a hard drive, disk, compact disc, punch card, tape or other computer readable material; in virtual memory on a network, a computer, an intranet, the Internet, the Abilene Project, or otherwise; on an optical storage device; on a magnetic storage device; and/or on an EPROM.

The computer program instructions may also be loaded, e.g., transmitted via a carrier wave, onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In general, the present invention defines a system and method for a user to utilize electronic forms for completing and submitting paperwork. Alternative embodiments add additional features such as allowing for electronic signature(s) and database management.

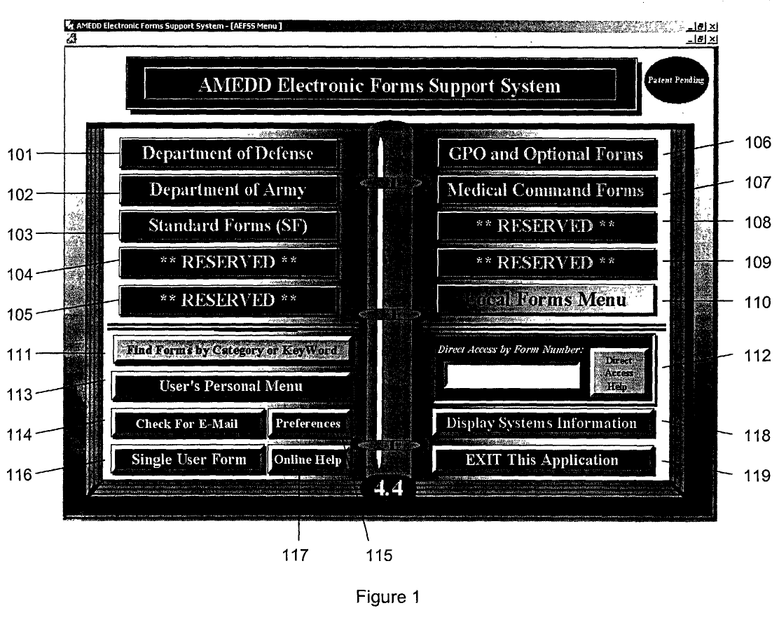

FIG. 1 illustrates a preferred embodiment of the user interface according to the invention that preferably includes an array of buttons 101-110 for interacting with the user and search tools 111, 112. Preferably, the buttons provide access to form groups 101-110. Buttons 101-110 may be any number of buttons and may include nonworking buttons 104, 105, 108, 109 to accommodate expansion of a forms database as illustrated in FIG. 1. The term “button” includes any type of linking known to one of ordinary skill in the art that will allow for the user to be provided with, for example, another screen, an interface box, and/or a response to the activation of the button after entry of information as will become more apparent based upon this description and the accompanying drawings.

Search tools 111, 112 preferably allow the user to search for a particular form without going through the form groupings. The search tool 111 preferably when selected allows the user to search for a form, for example, using a keyword related to a particular form or a partial form number. The search tool 112 allows the user to enter the form number and immediately pull up that requested form.

Also illustrated in FIG. 1 are links for alternative embodiments of the invention such as a personal menu button 113 for providing a grouping of forms selected by a particular user, a e-mail button 114 for checking for receipt of e-mail with forms, a preferences button 115 for setting preferences for a particular user, a single user form button 116 for accessing a non-provided form, a help button 117, a display systems information button 118 for providing information regarding the system, and an exit button 119 for quitting from the system.

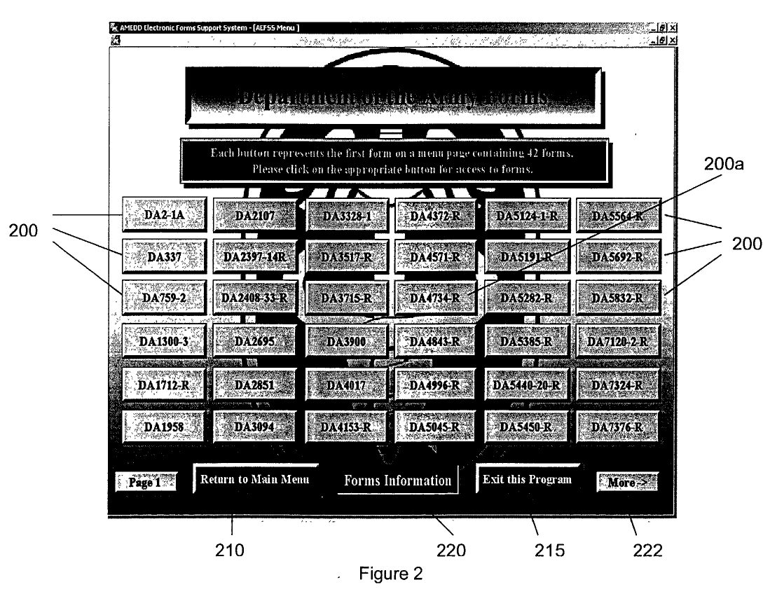

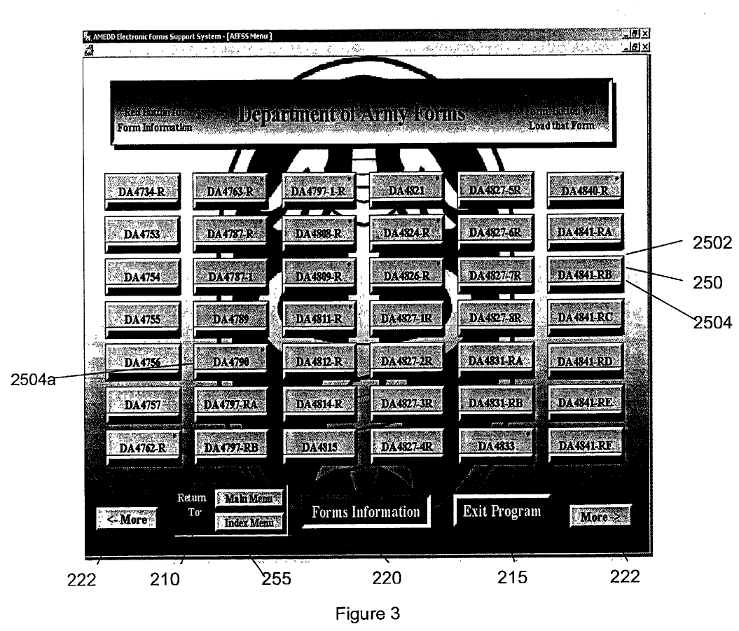

FIG. 2 illustrates an interface provided to the user based upon the user's selection of button 102 of the interface shown in FIG. 1. Preferably, each form subgroup button 200 that includes “DA______” provides access to a page having upwards of forty-two form buttons such as the interface illustrated in FIG. 3. The number of available form subgroups and forms themselves available in a particular interface screen can be adjusted by adjusting the size of, for example, the subgroup buttons 200 in FIG. 2. More preferably, the subgroups are based on every nth form number being displayed such that the forms between two consecutive form subgroup button identifiers will be within the form subgroup identified by the lower form number, i.e., “DA1712-R” is less than “DA1958”.

Preferably, the user is provided with a return to main menu button 210 and an exit button 215 in this interface. Alternatively, a forms information button 220 may be provided that will allow a list of the forms within this group to be listed including preferably information such as form number, form title and also possibly the version of the form and the form date. FIG. 2 also illustrates another alternative embodiment of a more button 222 for viewing an additional page of subgroup button(s).

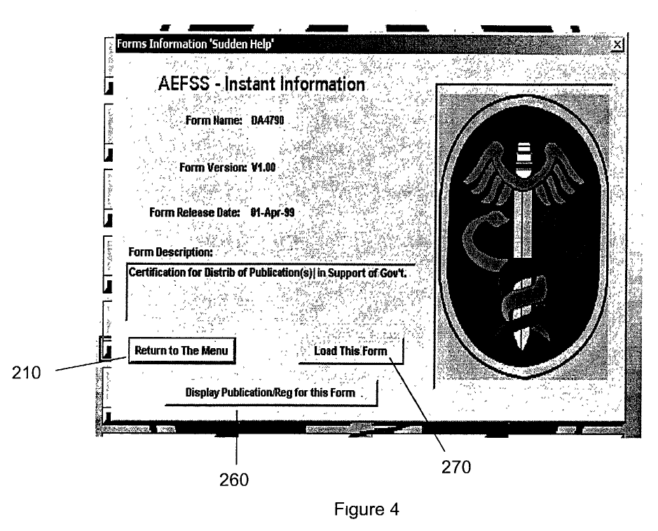

FIG. 3 illustrates an interface accessed by selecting button 200a, the use of “a” is to assist the reader in locating the selecting item, in the interface illustrated in FIG. 2. FIG. 3 illustrates an interface that provides access to forty-two different forms. As mentioned in connection to FIG. 2, the number of forms shown in an interface can be adjusted depending upon the size of the form buttons 250 which each preferably includes a form access portion 2502 and an information portion 2504. Preferably, each form button 250 will have on its face over the form access portion 2502 a form identifier such as its form number. The form access portion (or form portion) 2502 preferably when selected by the user will provide the form whose identifier is on the form button 250. The information portion 2504 preferably will provide a display that provides the user with information regarding a particular form, an example is FIG. 4 which is provided in response to the selection of information portion 2504a.

The interface shown in FIG. 3 also preferably provides the user with the main menu button 210 and exit button 215. This interface also may provide an index menu button 255 to return the user to the parent interface with the subgroup form buttons 200 such as the interface illustrated in FIG. 2. Alternatively, the interface illustrated in FIG. 3 may include a forms information button 220. Another alternative embodiment for this interface is the addition of more buttons 222′ for accessing the forms in the adjacent form subgroups.

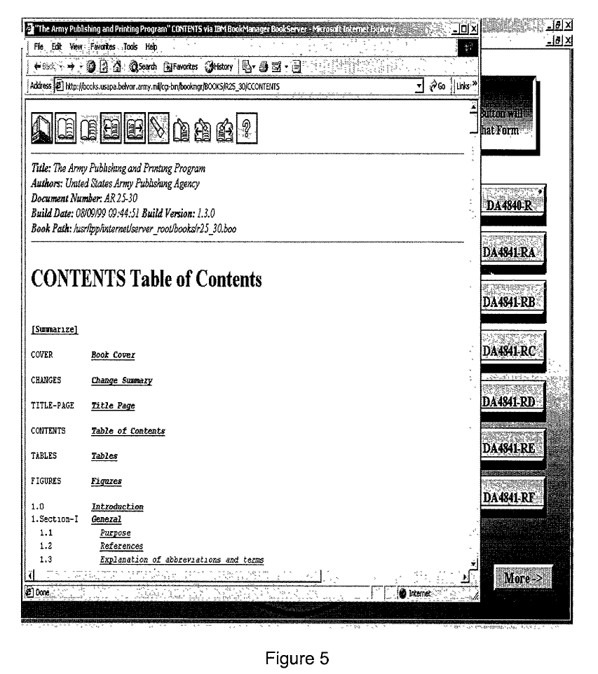

FIG. 4 illustrates an example of forms information interface that is accessible by selecting an information portion 2504, which in this case was information portion 2504a in the interface illustrated in FIG. 3. The forms information interface preferably includes a button 260 for obtaining additional information regarding a form such as the publication and/or regulation for a particular form. For the user's convenience the interface of FIG. 3 may include an indicator on the form buttons that have additional information that will be accessible, in the illustrated embodiment the forms include an “*” in the upper right hand corner of the button although it could be anywhere on or approximate to the button. Additionally, other types of identifiers may be used instead of an “*”. FIG. 5 illustrates a portion of the information available for form DA4790.

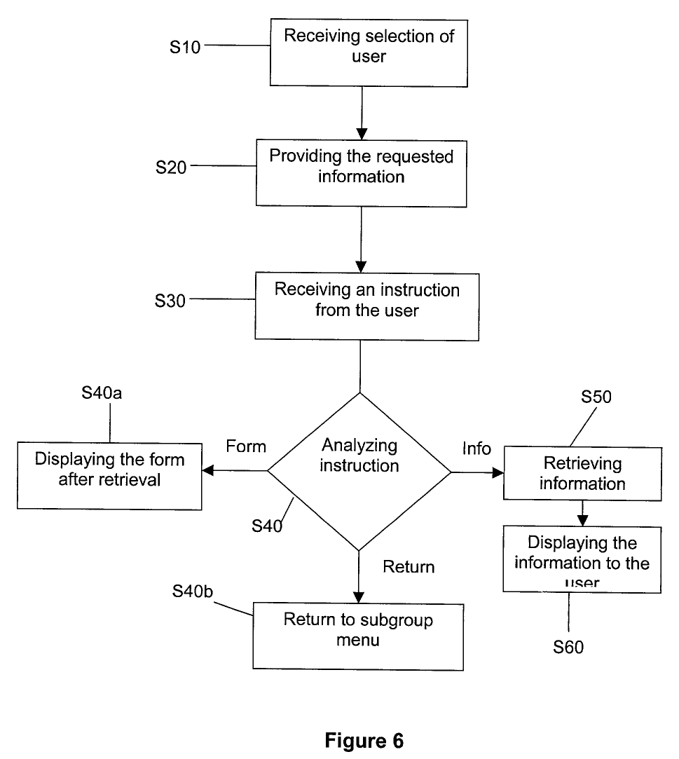

Preferably, the system performs the following method, which is represented in FIG. 6, to provide the information that is exemplified by FIG. 5. Preferably, when the user requests information regarding a particular form by selecting the information portion 2504 the first step is receiving that selection, S10. In response to the selection providing information regarding a form, S20. Preferably, the information is provided in an interface similar to that shown in FIG. 4. The next step, S30, preferably is receiving an instruction from the user representing the selection made by the user. Then, providing, S40, the user with the requested form by retrieving the form data from a form database, S40a, returning to the form subgroup interface, S40b, or providing additional information regarding a form. Preferably, the providing additional information includes retrieving the information from an information source, S50, and displaying that information to the user, S60. An exemplary way of performing step S60 is shown in FIG. 5, which illustrates the result of launching a browser to retrieve the information from an external location such as a website based upon a retrieved address associated with that particular form.

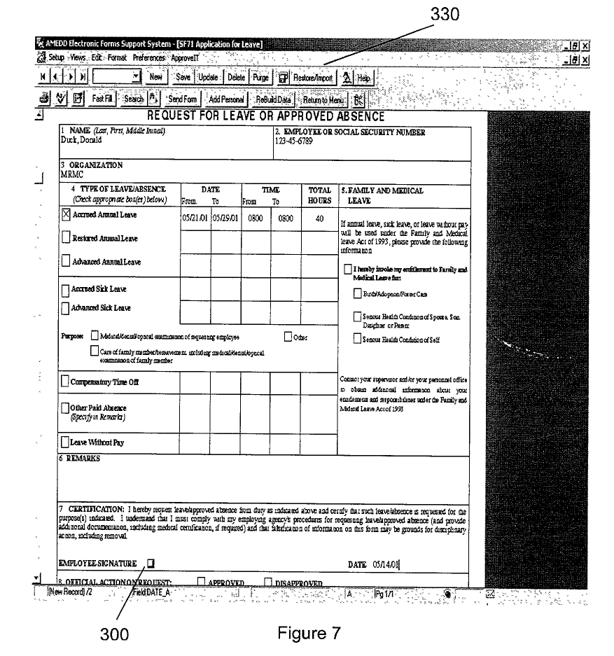

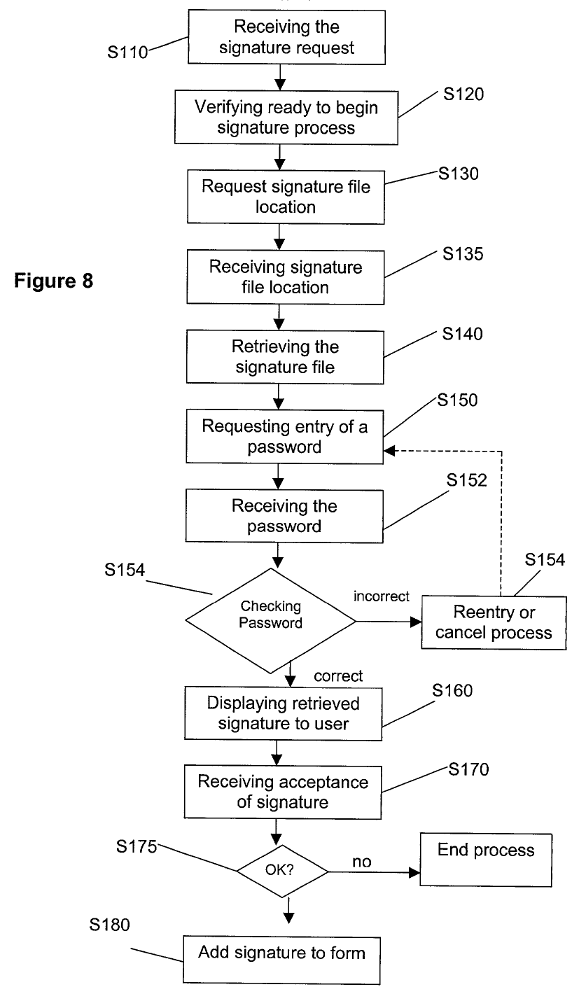

FIG. 7 illustrates a form window toolbar and an exemplary form, which in this example is form SF71. The exemplary form shows the form fields completed with fictional information and is ready for signing by the user. The illustrated form includes a selection box (or checkmark field) 300 that allows the user to select it and sign the form electronically. The user preferably clicks (or selects) the box 300 to begin the signature method according to this invention that is illustrated in FIG. 8.

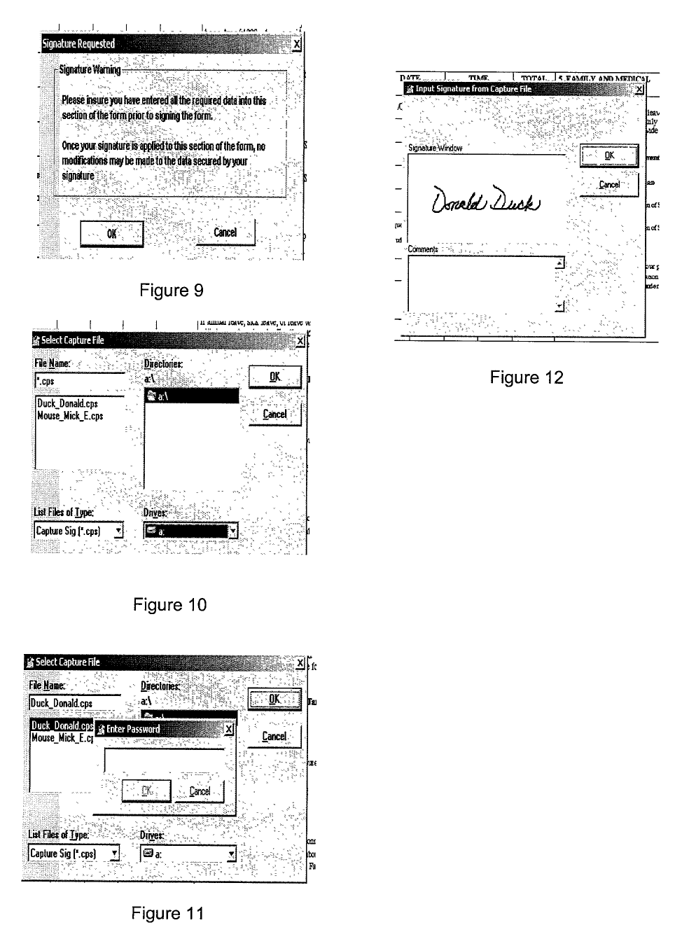

Preferably, the system upon receiving the signature request, S110, will inquire with the user for verification that the user has completed all of the fields that are to be completed by him/her prior to signing this form, S120. An exemplary interface for accomplishing step S120 is illustrated in FIG. 9. The verification preferably includes soliciting the verification from the user and receiving a response to the request from the user. Alternatively, step S120 may be omitted.

In response to the verification, preferably the system will request a location from which to retrieve the user's signature, S130. The next step preferably is receiving the signature file location, S135. A possible interface for accomplishing steps S130, S135 is illustrated in FIG. 10. Alternatively, the signature location made be preset based upon preferences to allow for the signature to automatically be pulled by the system upon verification. Based upon the location information, retrieving, S140, the signature file, which preferably includes a password or other security protections are provided by the system. Requesting entry of a password by the user, S150; receiving the entered password, S152; checking to see if the entered password is the correct password, S154, before proceeding to step S160. If the password is incorrect, performing a method allowing for reentry of the password and/or canceling the process depending upon design preference, S156.

Preferably, the user is allowed to view the retrieved signature prior to its placement on the completed form, S160. An exemplary interface for accomplishing this is illustrated in FIG. 12. Preferably, the next step is receiving a response from the user either accepting or not accepting the retrieved signature, S170. Based upon the response, the next step, S175, either ends this process, S177, or proceeds to the next step, S180. Alternatively instead of ending the process the user may be given the opportunity to select a different signature file, this would be advantageous when the user has multiple signature files such as a formal signature and a casual signature. Preferably, the next step is to add the signature to form, S180, as illustrated in FIG. 13. More preferably, the user is provided with an opportunity to cancel the process at each of the above steps.

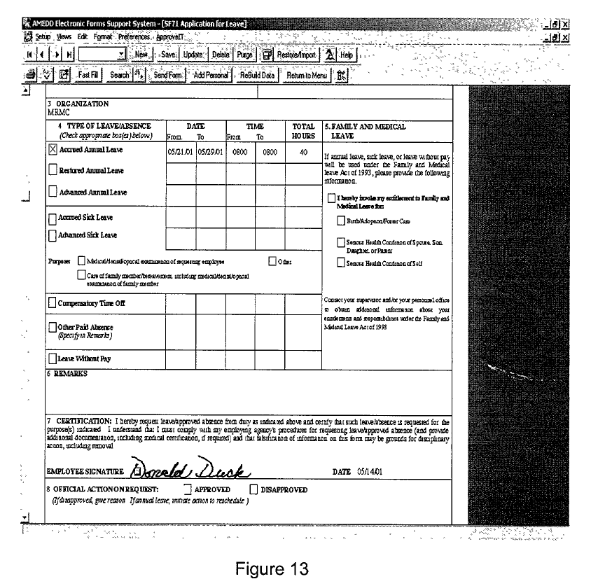

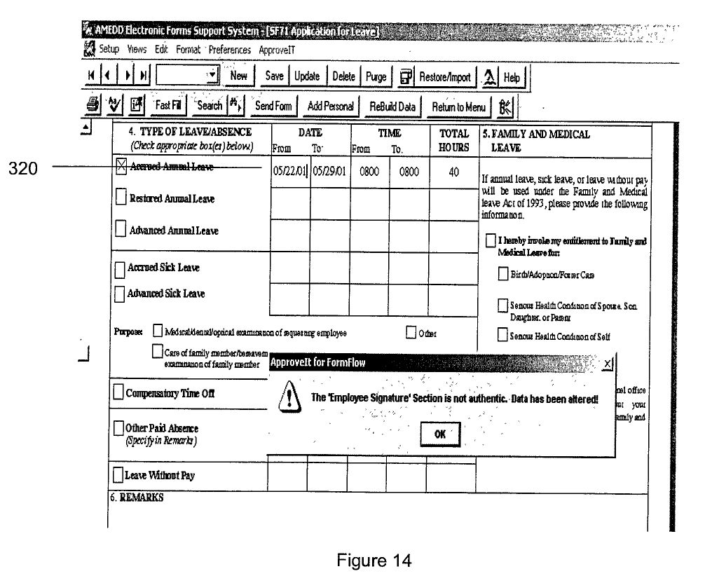

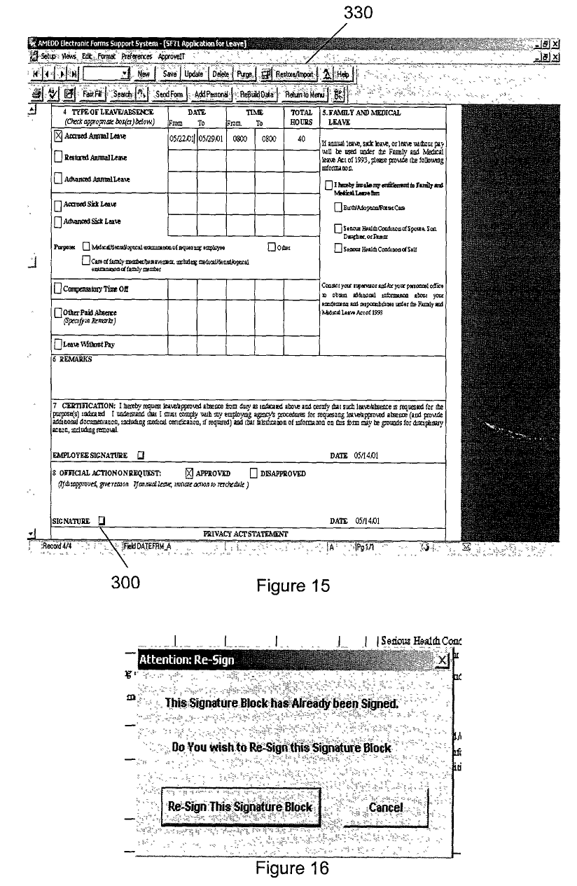

FIG. 14 illustrates an exemplary message to be displayed when data is altered after the signature is added to the form. In this example, the changed data is located in field 320. Preferably, when data is entered into a field a check is performed to determine whether a signature field is linked to that data field and that signature field includes a signature. Alternatively, this test could be performed when a request to print or save the form is received. If the data is changed after a signature has been placed in the linked signature file, then the signature preferably disappears from the form as illustrated in FIG. 15. The signature may be reapplied to the form by selecting signature box 300. FIG. 16 illustrates an exemplary interface for verifying that the user wants to reapply his/her signature to the form. If the user wishes to reapply his/her signature, then the user will preferably repeat the signature method described above or a method similar to that signature method.

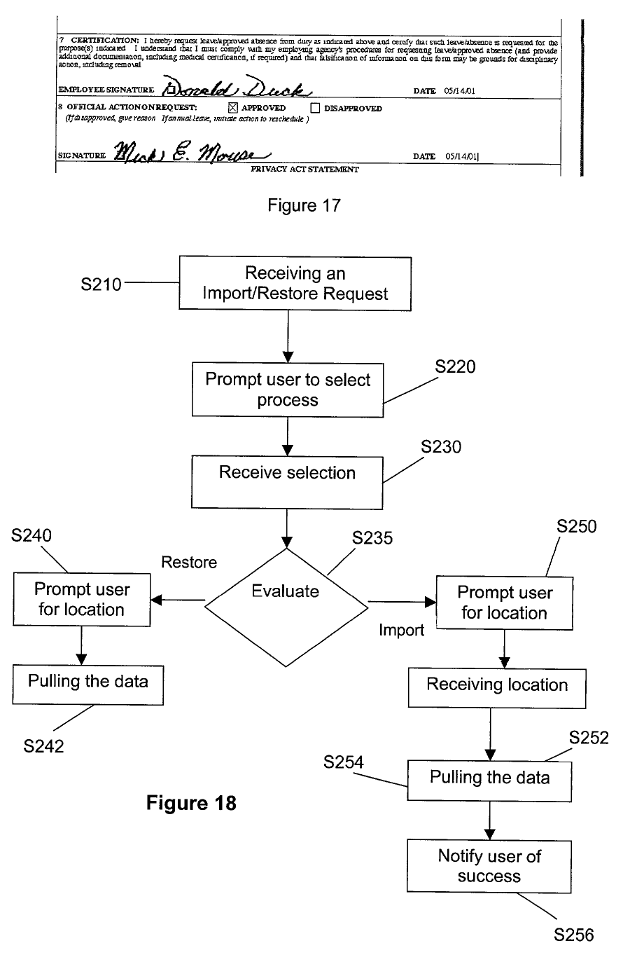

FIG. 17 provides an illustration of the form being signed by two different individuals.

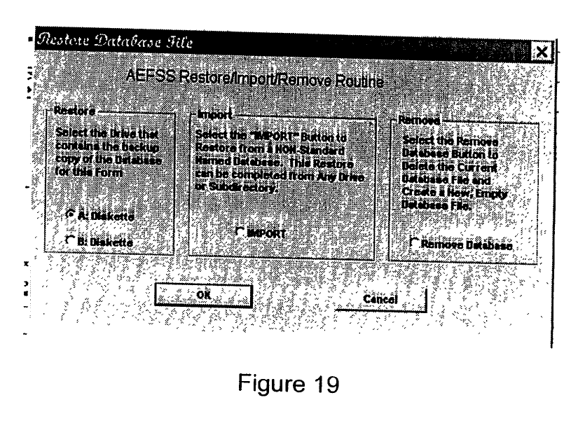

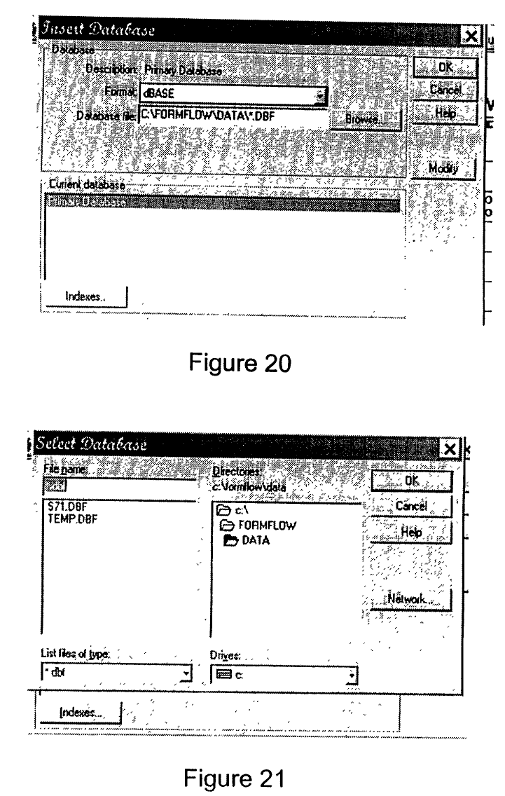

FIGS. 18-23 illustrate how records are imported and/or restored into the forms database. FIG. 18 more particularly illustrates the method as a flowchart while FIGS. 19-23 illustrate exemplary interfaces and/or messages the system may provide to the user to accomplish the method illustrated in FIG. 18.

The invention contemplates different ways in which this may be accomplished. A first way is that a common button 330 is provided in the individual form interface that prompts an interface similar to that illustrated in FIG. 19, which preferably includes a restore section and an import section. A second way is to provide separate buttons, i.e., one for the restore function and one for the import function. A third way is to provide only an import function.

The first step is receiving a request from the user to import and/or restore data into the current forms database, S210. The next step, S220, is to prompt the user to select either the restore process or the import process. The next step, S230, is to receive the user's selection and then proceed with the appropriate process, S235. The two processes will know be described separately while making reference to FIG. 18.

The restore process preferably includes the following steps. First, if this information is not provided, the user is prompted, S240, for the location of where a backup database is located. As illustrated in FIG. 19, this step may be accomplished as part of step S230. Preferably, the backup database is named for the form to which it will be brought into; however, if the backup database is a different name, then the user may also be prompted for the name of the backup database including possibly its location. The next step, S242, is pulling the data from the backup database into the form database. Preferably, then the user is notified in some manner of a successful transfer of the backup database, for example, by increasing the record count by the appropriate amount or providing a message.

The import process preferably includes the following steps. First, the user is prompted, S250, to provide the location of the data being imported into the file database as illustrated in FIG. 20. FIGS. 21 and 22 illustrate when the user requests the opportunity to browse through his/her computer files to locate the relevant data. The next step is receiving the location information from the user, S252. Based upon the data location pulling the data from that location into the file database, S254. Preferably, the system then notifies the user of a successful importation, S256, as exemplified in FIG. 23, but this step may be omitted.

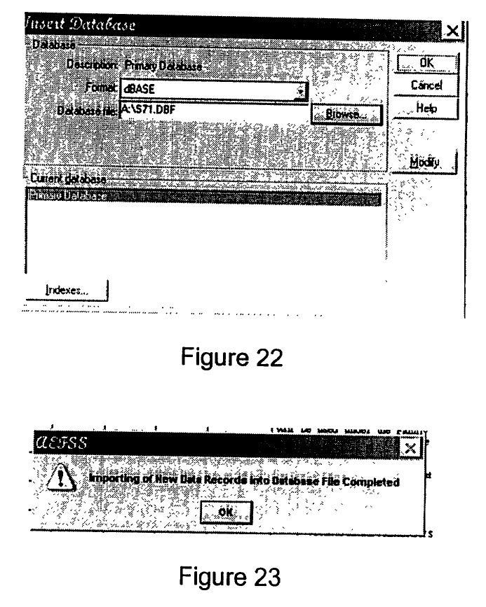

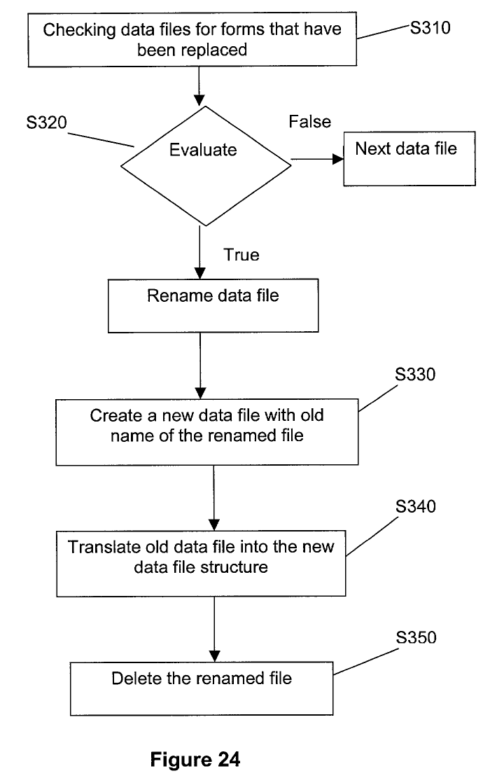

The invention also preferably includes a method to convert a prior form database to fit a new data structure present within a new form database, which replaces the prior form database. This method is illustrated in FIG. 24. Preferably, the conversion begins with checking, S310, the user's data directory for a matching data file for each form (record) in the system's database. Alternatively, this can occur for individual data files, for example, as selected by the user. The next step, S320, evaluates whether a data file exists for a form and when this evaluation is true, if it is true, then the data file is temporarily renamed, S322; otherwise the next data file is checked, S324. The next step, S330, is to create a new empty data file with the default data file name with the format of the current form file. Next, S340, the records in the temporary data file are then translated into the newly created default data file. The next step, S350, is to delete the temporary file. FIG. 25 illustrates a message interface that is useful in the above method. The translation step, S340, preferably includes moving data from fields that remain the same in both name and nature (i.e., remained numeric or character) while leaving the remaining fields in the replacement form blank. An alternative embodiment is translating a date field from a numerical representation (such as May 12, 1998) to a character representation (such as May 12, 1998) by correlating the individual components to a respective character representation or performing the reverse (i.e., character representation to numeric representation). Another alternative embodiment is to write the old form data into a form and save it as a PDF document for future retrieval.

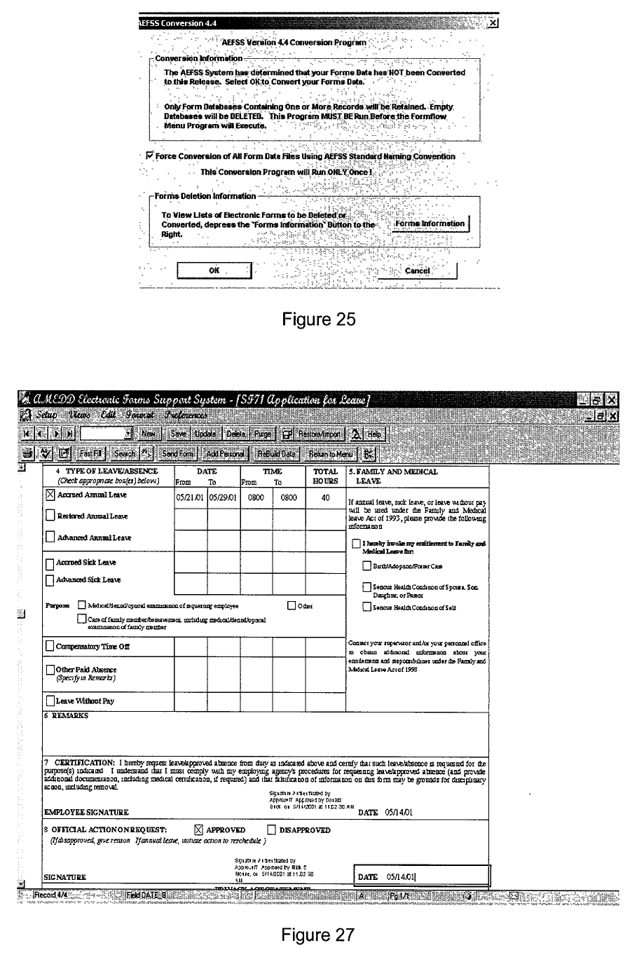

FIG. 26 illustrates a block diagram of the preferred implementation of the invention. As depicted, the functional components of the system 700 preferably include an electronic forms database 710, an interface engine 720, a front end 730, and a master database controller 740. The electronic forms database 710 preferably includes the data to create the electronic forms as requested by the user 780 through the front end 730 and the interface engine 720. The interface engine 720 as implemented may be FormFlow Filler including Forms Basic 725. The front end 730 preferably includes a menu system 735 to assist the user 780 in locating the form he/she wishes to complete. The front end 730 preferably interacts with the master database controller 740 to pull the forms information through the interface engine 720. The master database controller 740 preferably controls the operation of the front end 730 by determining what forms are being requested by the user 780. The master database controller 740 matches the selection with a file location, which is in turn passed to the interface engine 720. The interface engine 720 pulls the selected form and data based upon the provided file location.

The embodiment illustrated in FIG. 26 may alternatively be modified to include a local menu database 750. The local menu database 750 preferably includes a list of forms that at a particular site are commonly accessed and/or forms intended just for a particular site. Another possible alternative embodiment is to add an ActiveX interface 760 to provide a link between the interface engine 720 and a signature module 765 such as Silanis Approvelt software. Yet another possible alternative embodiment is to provide a messaging application program interface 770 between the interface engine 720 and an e-mail interface 775 such as Microsoft Exchange. Each of these alternatives is described more fully above in connection to the various methods that are encompassed by the present invention.

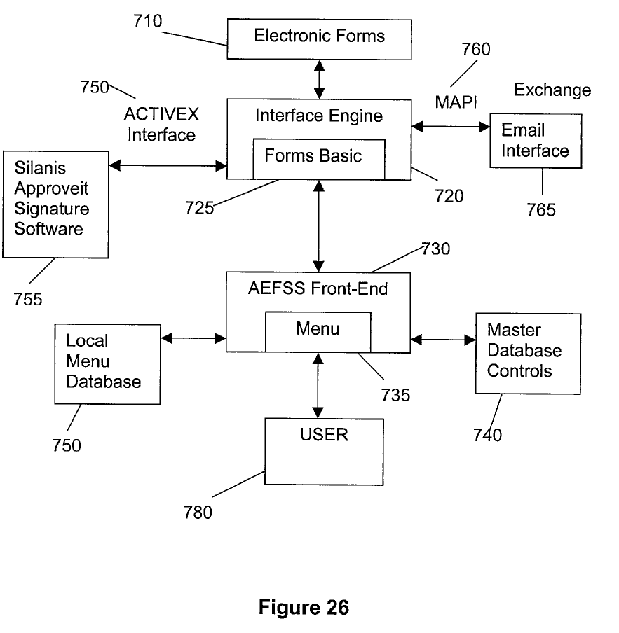

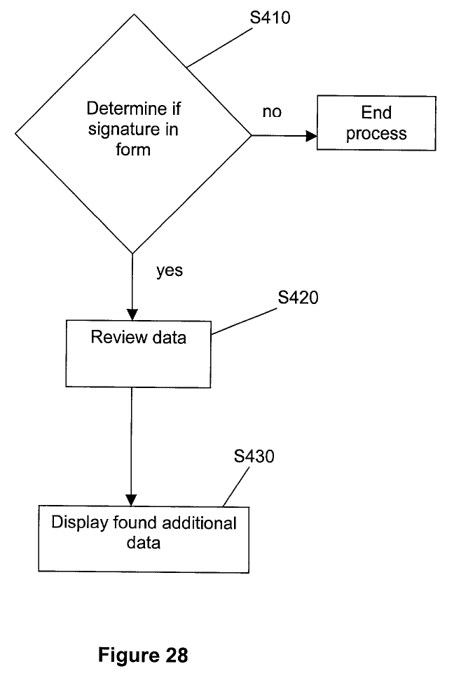

An alternative embodiment of the invention provides for identifying when a signature has been placed on a form, but the system is unable to display the actual signature as illustrated in FIG. 27. The method for accomplishing this is illustrated in FIG. 28. Preferably, the system predetermines (or is set with that predetermined information) its ability to display signatures on forms prior to actually opening such a form. First, the system preferably determines when opening data for a form whether a signature is present within that data, S410. When there is no signature, the step is opening the form and populating it with any data connected to the form, S415. When a signature is present, then reviewing the data for additional information that indicates who signed the form and preferably when that individual signed the form, S420. Displaying that additional information 430 in place of the electronic signature, S430, as illustrated in FIG. 27. A benefit to this functionality is that the signature data preferably provides authentication to the data present in the rest of the form as discussed above in connection with the signature method.

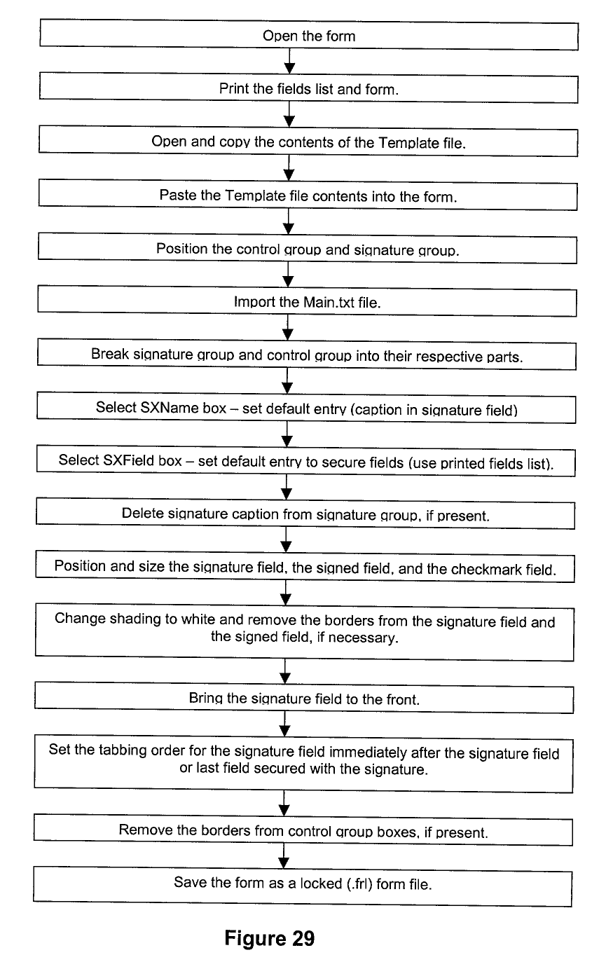

A further alternative method provides for the inclusion of one or more signature blocks in a form. Examples of where multiple signature blocks might exist are when a form needs to be approved by a supervisor(s) or multiple individuals need to sign a form such as an invention disclosure form. FIG. 29 provides a detailed flowchart of steps to incorporate signature blocks into a form using JetForm's FormFlow Form Designer to create an electronically signable form. This method preferably utilizes Silanis Technology's Approvelt software to enhance the form with the ability to secure fields and allow for a form to be electronically signed. The following description corresponds to FIG. 29 while providing additional details and further elaboration upon what is shown in FIG. 29.

The following description is for exemplary purposes only. This example assumes there are eight files to use in the design process. These files preferably are maintained in their own folder or directory. The eight files preferably include a) Sign1.frp thru Sign7.frp, which are a set of signature and control group templates, and b) a macro that preferably is imported into unlocked formfiles. The group a) files are named “Sign1.frp” for a one signature form, “Sign2.frp” for a two signature form, “Sign3.frp” for a three signature form, and so on, up to “Sign7.frp” for a seven signature form. Preferably, the appropriate number signature file will be used for a given form; for example, if a form includes three signature blocks the Sign3.frp file would be used. Each template file preferably includes two groups of items: (1) signature group that includes a signature field for a graphic signature, a signed text field that advises users who do not have Approvelt software that the form has been signed, and a checkmark field which indicates where a form user should click to electronically sign the form; and (2) control group that includes a set of fields to be configured to define default conditions. These files could include any number of group pairs.

Open the form to be designed. Preferably, print both the fields list and the form. Next open the template to copy its contents, i.e. the signature group and the control group. Paste the signature group and the control group (series of small boxes) into the form being designed. Position the control group preferably at the bottom center of the form outside the form margin. Next select the signature group and move it to the signature area on the form. Next, import the macro into the form file.

The next step is to break the control group into its individual boxes. In the control group, the first box preferably has the file name TSecCount. It will preferably be followed by a series of five boxes named S1Tok1, S1SigCount, S1Fields, S1Name, and S1TSCount, in that order. If a template for more than 1 signature is being used, then there will be an additional box for each signature and they will be named, S2Tok1, S2Sigcount, S2Fields, and so on, with the number 2 representing the number of signatures on the form.

Next, enter a plain text name into the S1 Name box. An example is using the box heading/caption of the signature field for the name.

When data fields on the form are to be locked once an electronics signature is placed, i.e., the data cannot be changed without the loss of the signature. Type in the dBase field name of each fillable field you want to secure with the signature making reference to the Fields List that was printed previously. Each field name you enter preferably will be separated by a pipe “|” character and a “|” must also be entered at the end of the string.

The next step is to break the signature group into its three fields, which are named: a graphic signature field, a signed text field, and a checkmark field. Delete the Signature1 caption at the top left of the group. Move and size the signature field to fit over the top of the signature box on your form. Move the checkmark field to the top right corner of your signature field. The checkmark field preferably is inside the borders of the signature field. The checkmark field is nothing more than a graphic object that indicates where form users must click with the mouse to sign the form. The user is actually clicking on the signature field, which activates the macro that finds and places the graphic signature on the form. Move the signed text field behind and slightly above the signature field. This field will notify users without Approvelt software that the form has been electronically signed. Preferably, the signed text field will not cover the checkmark field. Preferably and if necessary, remove the borders and the change the shading to white for the signature field and the signed text field. Then verify that the signature field is in front. Set the tabbing order for the signature field immediately after the signature field of your form. If your form does not have a fillable signature field, place the signature field immediately after the last fillable field secured with this signature.

The form has now been configured to accept electronic signatures. Preferably, the form is saved as a locked form file. If the form has more than one signature, preferably the relevant steps above are repeated for each signature on the form, i.e., breaking the control group and after.

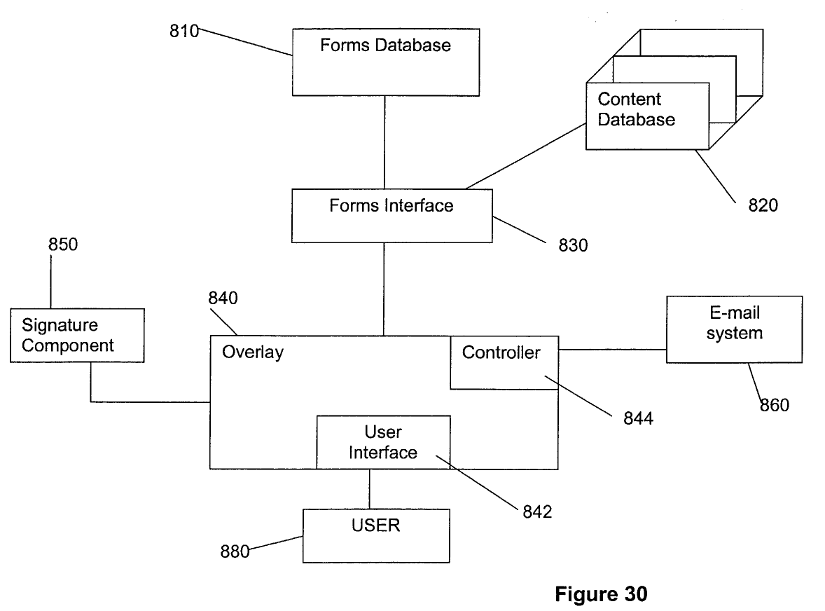

Another alternative embodiment of the invention is illustrated in FIG. 30 and includes a forms database 810, at least one content database for inputted data 820, a forms interface 830, and an overlay 840. This embodiment preferably is implemented as software on a processing device such as a microcomputer. The processing device may be part of a network of computers such that at least a portion of the overall system resides on a server that is accessible from a plurality of clients.

The forms database 810 preferably includes the data necessary to assembly each of the forms available within the system 800. The forms database 810 preferably is accessed by the forms interface 830 upon the direction of the overlay 840.

The content database 820 preferably includes all of the data entered previously at an individual workstation. The content database 820 also preferably includes a series of databases with each database having the previously entered data for one of the available forms in the forms database 810. The content database 820 preferably stores the data such that each previously completed and saved form is included within a data set. An alternative embodiment is that the content database 820 stores all data entered onto forms from a network of workstations.

The forms interface 830 preferably interacts with both the forms database 810 and the overlay 840. The forms interface 830 preferably renders the selected form based on data contained within the forms database 810 and the content database 820.

The overlay 840 preferably includes a user interface 842 and a controller 844 as illustrated in FIG. 30. FIG. 1 illustrates an example of the user interface 842. The user interface 842 allows for the user 880 to select the desired form a number of ways including directly entering the desired form number, accessing a personal menu, or through the form classification system. The personal menu preferably is a mechanism that allows the user to select forms that are commonly used by the user and put them into a personal menu by selecting the “Add Personal” button when the form is open, and the reverse applies when the user wants to remove the form from their personal menu by selecting the “Remove Personal” button. The form classification system allows for the form organizer to separate the forms into logical groupings, and as illustrated in FIGS. 2 to 5, the forms have been separated into the source of the form and then within each groupings of forms subdivided further sequential, which may not be necessary if there are only a few forms within the system 800.

The controller 844 preferably is what controls the other components of the system 800 based at least in part on what the user does and/or requests to be done through the user interface 842. The controller 844 preferably interacts with the forms interface 830 to call/retrieve forms from the forms database 810 and data from the respective, if there is an individual content database for each form, content database 820 for that form. The controller 844 assists in completing the form shown on a monitor based upon directions received from the user 880 such as moving between fields and/or insertion of data into a particular field. The controller 844 directs the forms interface 830 when and where to save the contents of an individual form based on the directions of the user 880 as preferably embodied by selection of buttons and/or menu options. Preferably, the form contents are saved into the appropriate contents database(s) 820 such that when the respective form is open again at that computer the previously entered form contents are accessible using arrow keys located above the form.

An alternative embodiment allows individual forms to be electronically signed by the user 880 through a signature component 850. Preferably, once the user 880 completes the form portions applicable to him/her, then the user 880 will be able to electronically sign the form by selecting the signature option and entering a password once prompted by the overlay 840. Preferably, the form contents will be locked in their current state such that if a field on the form is changed, the electronic signature will not appear upon a printed version of the form and the fact a change occurred after placement of the signature will be duly noted and/or indicated. Preferably, the signature is accomplished using hash fields so that if there is a change the signature disappears. The user 880 will be prompted for their private key, thus on a multi-user station, preferably the user 880 will need to select a key prior to entering an appropriate password. However, the design of the system 800 may be such that the appropriate key is located based on a previous user log in into the computer network. Preferably, if a change occurs and the signature disappears, the signing user then can click a box to have the signature reappear.

Another alternative embodiment is the inclusion of a connection to an e-mail system 860 such that a produced form may be e-mailed, for example, to a supervisor for his review or placement of an electronic signature in conjunction with the previous alternative embodiment. The overlay 840 preferably in this alternative embodiment will make the appropriate settings to have the system 800 interface appropriately with the e-mail system 860. A modification of this embodiment is to include a rule-based directing of the e-mailed form through appropriate departments/personnel for a particular form based on that form. An alternative to this modification is to allow the user 880 to predetermine the routing for a particular completed form such that after each step of the process, the user 880 determines who will receive the form next. Both of these modifications may be modified to allow for an acknowledgment option that will send status e-mails back to the user 880 as the form makes its way through the various departments/personnel.

A further alternative embodiment is to include a help feature to provide online assistance and troubleshooting, which in turn will reduce the use of a help desk by users who are looking for assistance. Preferably, the user will be able to request help for each button and/or menu option within the system from the starting user interface all the way through to the forms interface. A further modification adds help information and/or general information as to how to complete a field within a form by selecting help. This may be accomplished a variety of ways including a hypertext link to the Internet or some internal information source. An example of a help component is RoboHelp or the help feature present in Microsoft Office 2000.

Yet a further alternative embodiment is to include a rules component to review the content of forms to insure the correct type of information has been entered onto the form. If the rules component determines that an incorrect type of information has been entered for example a date into a name field, then the rules component preferably will notify the user of this error. The rules component may also include a spell checking capability to spot potentially misspelled words and preferably offer suggestions as to a correct spelling of the located word to the user.

A still further alternative embodiment is a component within the overlay to rebuild (and/or convert) content database, for example, when there is an error within that respective content database or the form has changed. The conversion may occur upon initial installation of an upgrade at the location of the contents database, form by form as the respective contents database is opened, or upon initiation by the user or an administrator at some other time than when the contents database is being accessed for information to be displayed.

Another alternative embodiment is to allow the user to attach supporting documentation to a form. Examples of this would be attaching receipts to an expense report or images to an invention disclosure form. The attaching of documentation may be for inclusion within the form database accessed by the user and/or forwarding of the form to a supervisor or another person via e-mail as part of a package.

The method for attaching documentation to an e-mail is as follows. First, the user opens the desired form, if it is not already opened. The user then selects the send button (Send Form). The user then addresses the form to the desired recipient(s). The user next selects the Package tab and clicks on the Include Files button. If the user is unsure of where the file is to be attached, the user then should select the browse feature to be able to locate the file similar to the way the browse feature works in different Windows based programs. Once the file is located, the user then selects to add the file. An alternative embodiment may ask for confirmation of the selection by the user.

The method for receiving such a package by e-mail preferably includes receiving the form, opening the form, examining the package for attachments, and updating the package for further routing. The updating the package when an attachment needs to be modified, changed, and/or deleted preferably includes deleting the form attachments, adding a modified/new version of the attachments back into the package, and setting any radial buttons/flags/options. If the user wishes to view the attachments, then the user preferably will open the form and select to open the attached files. The user may then be prompted to select a particular file or alternatively, all of the files may open in appropriate application(s) for viewing by the user.

Another alternative embodiment adds an audit feature to the system to track form usage. The audit component preferably is included within the controller of the overlay to track, which forms are being used and preferably how long those forms are open to better quantify savings that are possible with the system and as a tool to indicate if a particular form should be revised for easier use.

A further alternative embodiment incorporates intelligent forms within the forms database. Intelligent forms preferably will notify the controller that they are smart and to allow the controller to return control back to the intelligent form. The intelligent form preferably will be able to determine who opened the form and incorporate the appropriate base information into the form without the user performing any actions beyond opening the form and completing the remaining parts of the form requesting specific information. Examples of the information that might be retrieved includes name, social security number, and contact information from another form or another information source without requiring the individual to reenter the information each time he opens up a new form.

The invention is contemplated including methods to produce and utilize information from the various exemplary interfaces shown in the drawings and discussed within this description including similar interfaces and any variants that would provide the same effect.

Although the present invention has been described in terms of particular preferred embodiments, it is not limited to those embodiments. Alternative embodiments, examples, and modifications which would still be encompassed by the invention may be made by those skilled in the art, particularly in light of the foregoing teachings.

Furthermore, those skilled in the art will appreciate that various adaptations and modifications of the above-described preferred embodiments can be configured without departing from the scope and spirit of the invention. Therefore, it is to be understood that, within the scope of the appended claims, the invention may be practiced other than as specifically described herein.

We claim:

1. A method for placing an signature on a form comprising:
receiving an signature request from a user,
verifying that the user has completed the user's portion of the form after receiving the request from the user
retrieving the signature,
performing a security verification that the signature corresponds to the requesting user, and
adding the signature to the form.

2. The method according to claim 1, further comprising requesting a location of the signature prior to retrieving the signature.

3. The method according to claim 1, wherein said performing step includes
requesting entry of a password by the user,
receiving the entered password from the user,
comparing the entered password to the password associated with the signature such that if the passwords are unequal repeating the first three steps in this claim, else adding the signature to the form.

4. The method according to claim 1, wherein said performing step includes
requesting entry of a password by the user,
receiving the entered password from the user,
comparing the entered password to the password associated with the signature such that if the passwords are unequal returning to the form from that the user requested be signed, else adding the signature to the form.

5. The method according to claim 4, wherein prior to the adding step performing the following:
displaying the retrieved signature to the user, and
receiving an acceptance from the user of the signature.

6. The method according to claim 1, wherein the signature is an electronic signature.

7. A computer data signal embodied in a carrier wave readable by a computing system and encoding a computer program of instructions for executing a computer process performing the method recited in claim 1.

8. A computer-readable medium having computer-executable instructions for the method recited in claim 1.

9. A method for displaying signature information without displaying the signature comprising:
determining whether a data to populate a form includes a signature, when the data includes a signature performing the following
pulling information regarding the signature, and
authenticating the populating data to verify no changes have occurred in data fields linked to the signature, and
when no changes have occurred displaying the signature information in place of the signature.

10. A computer data signal embodied in a carrier wave readable by a computing system and encoding a computer program of instructions for executing a computer process performing the method recited in claim 9.

11. A computer-readable medium having computer-executable instructions for the method recited in claim 9.

12. A method for adding a signature functionality to a form comprising locating in the form signature template fields such that a signature field covers an area where a signature is to be located and an option for informing a form system to insert a signature in the signed field within the signature area of the form.

13. The method according to claim 12, further comprising placing the option over the signature field such that a user will associate selecting the option with obtaining the placement of a signature.

14. The method according to claim 12, wherein the option upon selection will activate a macro to find and place the signature within the signature field.

15. The method according to claim 12, wherein the signature template fields include a signed text field.

16. The method according to claim 12, further comprising prior to the locating step:
opening a form previously designed,
opening a template file, and
copying the signature template fields from the template file.

17. The method according to claim 16, wherein the locating step includes placing the copied signature template fields onto the form.

18. The method according to claim 17, further comprising linking data fields within the form to the signature field such that once the signature is placed within the signature field the signature will disappear upon a change being made in at least one linked data field.

19. The method according to claim 18, wherein the signature will disappear upon the form being saved.

20. The method according to claim 18, wherein the signature will disappear upon the form being updated.

21. The method according to claim 18, wherein the signature will disappear upon the form being printed.

22. The method according to claim 12, wherein the signature template fields include a control group having at least one box.

23. A computer data signal embodied in a carrier wave readable by a computing system and encoding a computer program of instructions for executing a computer process performing the method recited in claim 12.

24. A computer-readable medium having computer-executable instructions for the method recited in claim 12.

25. A method for providing information regarding a form to an user, comprising:
displaying an array of form buttons having a link to a form and an information link,
receiving a information request triggered by selection of the information link by the user, and
displaying information regarding the form to the user.

26. The method according to claim 25, further comprising:
offering the user an option to obtain additional information regarding a form,
receiving the notice of the selection of the option by the user,
retrieving additional information, and
displaying additional information to the user.

27. The method according to claim 26, wherein the retrieving step includes
pulling a website address from a database, and
opening a browser such that the browser pulls information from the website address.

28. A method for adding data to a data file for a particular form comprising:
receiving a request from a user to pull data from a source external to the current data file,
prompting the user for a location of the external data source,
receiving location information from the user,
pulling the external data based upon the location information, and
adding the external data to the current data file.

29. The method according to claim 28, wherein the current data file is an empty data file.

30. The method according to claim 28, wherein the external data is backup data.

31. The method according to claim 28, wherein the prompting step includes providing the user the opportunity to browser through directories to locate the external data.

32. The method according to claim 28, wherein the external data is contained within a data file with a name that is different from the form name.

33. A computer data signal embodied in a carrier wave readable by a computing system and encoding a computer program of instructions for executing a computer process performing the method recited in claim 28.

34. A computer-readable medium having computer-executable instructions for the method recited in claim 28.

35. A method for converting a data file for an old form replaced by a new form comprising:
renaming the data file for the old form,
creating a data file using the former name of the data file for the old form, and
translating the data from the data file for the old form to the data file for the new form.

36. The method according to claim 35, further comprising deleting the data file for the old form.

37. A system comprising:
means for providing a main interface,
means for allowing a user to access a form within three clicks beginning at the main interface,
means for displaying a form with at least one field that the user may fill with data, and
means for storing data entered into the fields of forms within said system.

38. The system according to claim 37, further comprising means for converting data entered for an out-of-date form to a data structure of a newer form that replaced the out-of-date form.

39. The system according to claim 37, further comprising means for the user to sign a form.

40. The system according to claim 39, further comprising means for a second user to sign the form signed by the first user.

41. The system according to claim 37, further comprising means for providing information about at least one form.

42. The system according to claim 37, further comprising means for adding external data to a data file associated with a form opened by the user.
